(19) United States
(12) Patent Application Publication
(10) Pub. No.: US 2007/0182115 A1
(43) Pub. Date: Aug. 9, 2007

(54) Aircraft tire dolly

(76) Inventor: Kim C. Groomes, Hartland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/348,137

(22) Filed: Feb. 6, 2006

(51) Int. Cl. B62B 5/00

(52) U.S. Cl. 280/79.4

(57) ABSTRACT

The invention is a wheel jack having a cradle for a wheel. The cradle has a first surface and a second surface. The second surface is spaced from the first surface to form a wheel space. An actuator moves the first surface relative to the second surface along a horizontal direction to lift or lower the wheel in the cradle.

### BACKGROUND OF THE INVENTION

This invention relates to a tire jack for an aircraft wheel.

An aircraft may require service of the wheels of its landing gear. Typically, a strut of the wheel is lifted by a jack operated by a technician. Another technician is then required to remove the tire from the lifted strut. These tires are very heavy and difficult to handle. If the tire is to be returned to the strut or a new tire placed on the strut, two technicians may be required to hold the tire to ensure correct alignment of the tire on the hub of the strut. It is therefore desirable to reduce the labor involved in this operation.

In addition, existing tire dollies and jacks for aircraft have a high profile. This profile may make it difficult to maneuver the dolly or jack around the aircraft. A need therefore exists for a tire dolly or jack having a lower profile.

### SUMMARY OF THE INVENTION

The present invention comprises a wheel jack having a cradle for a wheel. The cradle has a first surface spaced from a second surface. The wheel is received in the space defined by the surfaces. An actuator, such as a hand crank, permits one surface to be driven horizontally closer or apart from the other surface. A wheel seated on these surfaces will be raised when the surfaces are brought together and lowered when the surfaces are brought apart. In this unique way, a wheel may be vertically lifted by horizontal movement of the surfaces supporting the wheel. This permits the invention to have a low profile.

An actuator is linked to the first surface and the second surface. The actuator, such as a hand crank, permits one surface to be brought toward the other surface or moved away. In addition, each of the surfaces have rollers that permit the wheel to be rotated while in the cradle. This feature permits the wheel to be aligned with the hub of the aircraft strut with less labor.

In addition, the cradle may be mounted to a set of wheels to permit the wheel jack to be easily maneuvered around the aircraft. One set of wheels may be mounted to the first surface while a second set of wheels may be mounted to the other surface. These wheels further assist one surface to be moved relative to the other in the horizontal direction to lift or lower the wheel.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a perspective view of the inventive wheel jack, including wheel cradle, first surface and second surface, and actuator.

FIG. 2 illustrates another perspective view of the inventive wheel jack of FIG. 1, showing without wheel the first surface and the second surface and actuator.

FIG. 3 illustrates the inventive wheel jack with wheel supported by first surface and second surface of the wheel cradle.

FIG. 4A illustrates a cross-sectional view of the actuator of FIGS. 1 and 2.

FIG. 4B illustrates a cross-sectional view of the actuator of FIG. 4A with rod extended.

FIG. 5 illustrates schematically the movement of first surface and second surface.

### DETAILED DESCRIPTION OF THE PREFERRED EMBODIMENT

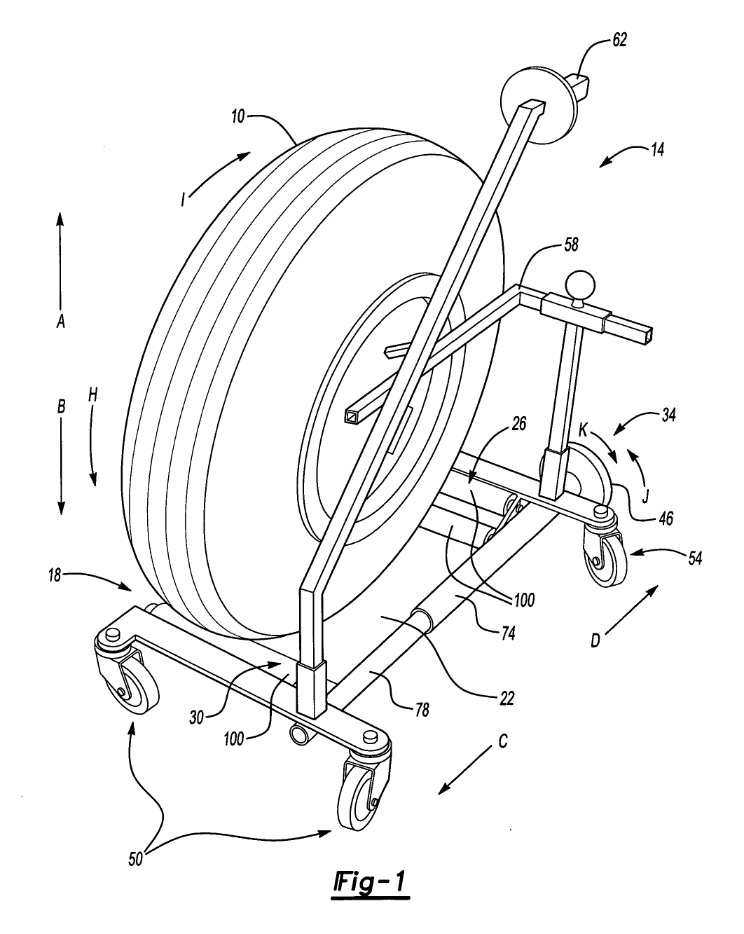

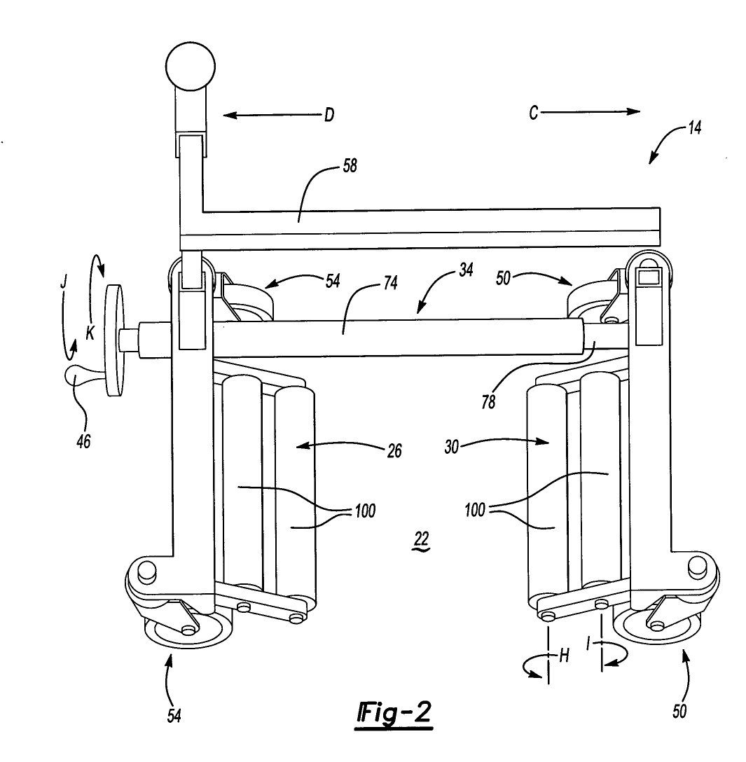

FIG. 1 illustrates a perspective view of inventive wheel jack 14. As shown, wheel jack 14 has wheel cradle 18 that receives wheel 10. Wheel cradle 18 has first surface 26 and second surface 30 defining wheel space 22. First surface 26 and second surface 30 permit rotation of wheel 10 on its axis, say along the direction of arrow H or the direction of arrow I as shown in FIG. 1 and FIG. 2. This feature permits wheel 10 to be rotated in alignment with a hub of an aircraft strut (not pictured). As shown in the drawings, first surface 26 and second surface 30 may comprise a set of rollers 100 arranged along an incline, although each surface 26, 30 may employ a single roller to achieve the object of the invention.

Actuator 30 is linked to drive first surface 26 relative to second surface 30. By turning crank 46 in the direction of arrow K, second surface 30 may be moved in the horizontal direction of arrow C, i.e., away from first surface 26. Alternatively, if crank 46 is turned in the direction of arrow J, as shown by FIGS. 1 and 2, second surface 26 may be moved in the direction of arrow D, i.e., towards first surface 30. In this way, wheel space 22 may be decreased if second surface 30 is moved in the direction of arrow D or increased if moved in the direction of arrow C.

As shown schematically by FIG. 5, movement of first surface 26 relative to second surface 30 permits wheel 10 located in wheel space 22 to be raised in the direction of arrow A or lowered in the direction of arrow B by horizontal movement of the first and second surfaces 26, 30 relative to one another. As seen in FIG. 5, wheel 10 is shown in the lifted position 66 when first surface 26 and second surface 30 are brought close to one another. Wheel 10 may be lowered by moving second surface 30 relative to first surface 26 in the direction of arrow C to the position designed by 30′ and shown schematically. At this point, wheel 10′ as shown by dashed lines is located on ground 74. Wheel 10 may again be raised by moving second surface 30 closer to first surface 26 in the direction of arrow D. In this way, wheel 10 may be raised and lowered by horizontal movement of first surface 26 relative to second surface 30.

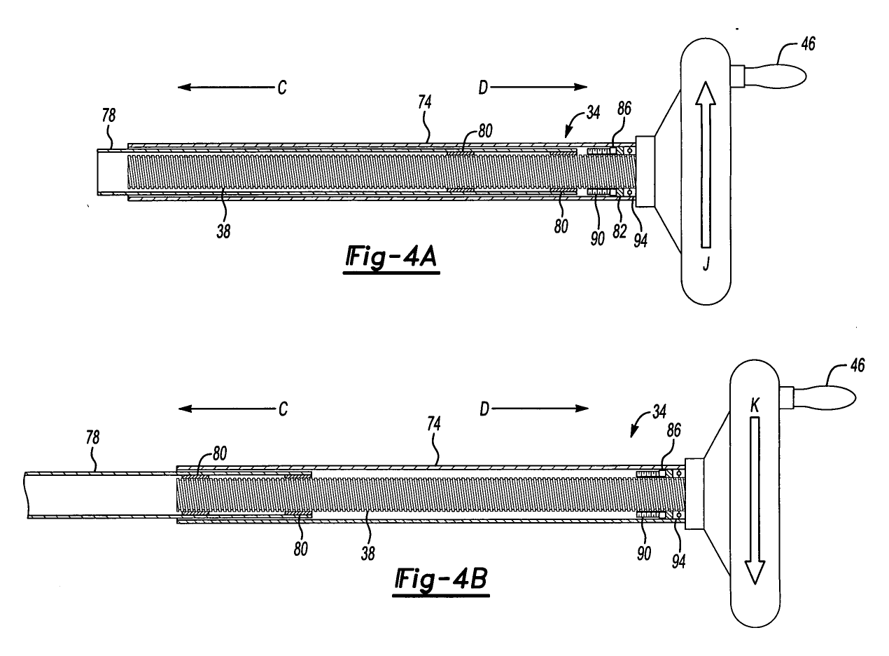

FIGS. 4A and 4B illustrate actuator 34 of FIGS. 1 and 2 in cross-section. As shown, actuator 34 has first tube 74, which is formed together with first surface 26 and second tube 78, which is formed as part of second surface 30. Second tube 78 is slidably received within first tube 74 and moves relative to first tube 74 in the direction of arrow C or in the direction of arrow D. Movement is accomplished by turning crank 46, which is fixed in rotation with threaded rod 38.

As mentioned earlier, turning crank 46 in the direction of arrow K moves second surface 30 away from first surface 26. As shown in FIG. 4B, crank 46 is turned in the direction of arrow K, which turns threaded rod 38 in the same direction. Threaded rod 38 is threadingly received by second tube 78, which has inner threads as provided by two nuts 80 fixed to second tube 78. Rotation of threaded rod 38 thereby causes second tube to extend outward from first tube 74. In this way, wheel 10 may be lowered. Also, wheel 10 may be raised by rotating crank 46 in the direction of arrow J. Second tube 78 is brought to the position shown in FIG. 4A. to prevent threaded rod 38 from extending outward in the direction of arrow D from first tube 70, first tube 70 has stop 82. Seated next to stop 82 is a Teflon thrust washer, washer 86. Washer 86 provides a friction free surface upon which set screw 90 rotates. Set screw 90 is fixed to threaded rod 38. Hence, rotation of crank 46 in the direction of arrow J moves second tube in the direction of arrow D. However, set screw 90 cannot rotate past stop 82 so thread rod 38 is prevented from moving in the same axial direction. Thrust bearing 94 is provided to allow crank 46 to rotate smoothly.

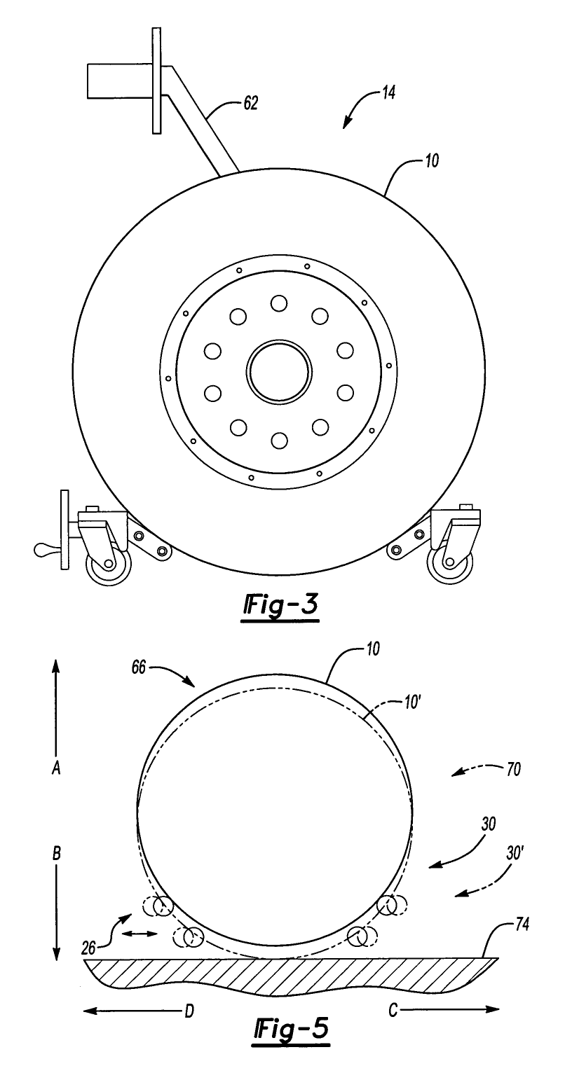

To facilitate movement of first surface 26 relative to second surface 30, each surface 26, 30 is provided with a set of wheels so that the surfaces may roll horizontally in the direction of arrow C and the direction of arrow D more easily. First surface 26 has second set of wheels 54 while second surface 30 has first set of wheels 50 as shown in FIG. 2. Wheels 50, 54 permit both surfaces 26, 30 to roll relative to one another. Wheels 50 and 54 may be caster wheels as shown in FIG. 2 that permit wheel jack 14 to move horizontally in all directions so that wheel 10 may be transported very easily. In addition, as shown in FIGS. 1 and 3, wheel jack 14 may be provided with handle 62 to maneuver wheel jack 14.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A wheel jack comprising;
a wheel cradle for vertically moving a wheel, said wheel cradle having a wheel space to receive the wheel;
said wheel cradle having a first surface and a second surface, said second surface spaced from the first surface, said first surface and said second surface forming said wheel space; and
an actuator for moving said first surface relative to said second surface, said first surface movable by said actuator along a horizontal direction under the wheel to move the wheel vertically.

2. The wheel jack of claim 1 wherein said first surface is movable relative to said second surface along said horizontal direction.

3. The wheel jack of claim 2 wherein movement of said first surface relative to said second surface alters said wheel space.

4. The wheel jack of claim 1 including a set of wheels permitting movement of said wheel cradle.

5. The wheel jack of claim 1 wherein at least one of said first surface and said second surface comprises a roller.

6. The wheel jack of claim 1 wherein said actuator moves said first surface by rotation of a threaded rod.

7. The wheel jack of claim 1 wherein said wheel cradle includes a vertical support to prevent movement of the wheel.

8. A wheel jack comprising:
a cradle for a wheel, said cradle comprising a first surface spaced from a second surface to define a wheel space;
an actuator for moving at least one of said first surface and said second surface, said first surface movable relative to said second surface by said actuator along a horizontal direction;
wherein at least one of said first surface and said second surface has a rotating surface permitting rotation of the wheel;
a first set of wheels mounted to said first surface permitting movement along said horizontal direction; and
a second set of wheels mounted to said second surface permitting movement along said horizontal direction.

9. The wheel jack of claim 9 wherein movement of said first surface relative to said second surface alters said wheel space.

10. The wheel jack of claim 8 wherein said rotating surface comprises a roller.

11. The wheel jack of claim 8 wherein said actuator moves said first surface by rotation of a threaded rod.

12. The wheel jack of claim 8 wherein said wheel cradle includes a vertical support to prevent movement of the wheel.

13. A method of vertically moving a wheel, the method comprising the steps of:
a) placing a wheel in a cradle, the cradle having a first surface and a second surface;
b) driving the first surface along a horizontal path relative to the second surface;
c) moving the first surface underneath the wheel; and
d) vertically moving the wheel as a consequence of step c).

14. The method of claim 13 wherein vertically moving comprises lifting.

15. The method of claim 13 wherein vertically moving comprises lowering.

16. The method of claim 13 including the step of:
e) positioning the cradle under the wheel.

17. The method of claim 13 including the step of:
f) rotating the wheel on the first surface and the second surface.
